(19) United States
(12) Patent Application Publication
(10) Pub. No.: US 2013/0311352 A1
(43) Pub. Date: Nov. 21, 2013

(54) SECURITIES TRADING SIMULATION SYSTEM

(71) Applicants: TOSHIBA SOLUTIONS CORPORATION, Minato-ku (JP); KABUSHIKI KAISHA TOSHIBA, Minato-ku (JP)

(72) Inventors: Eiji KAYANUMA, Tokyo (JP); Hiroshi ARAI, Tokyo (JP); Kentaro HATADA, Tokyo (JP); Nobuyoshi USAMI, Tokyo (JP); Tomohiro KURIHARA, Tokyo (JP); Haruo SATOU, Tokyo (JP)

(73) Assignees: TOSHIBA SOLUTIONS CORPORATION, Minato-ku (JP); KABUSHIKI KAISHA TOSHIBA, Minato-ku (JP)

(21) Appl. No.: 13/949,942

(22) Filed: Jul. 24, 2013

Related U.S. Application Data
(63) Continuation of application No. PCT/JP2011/057393, filed on Mar. 25, 2011.

(30) Foreign Application Priority Data
Jan. 25, 2011 (JP) 2011-013021

(51) Int. Cl. G06Q 40/04

(52) U.S. Cl. CPC G06Q 40/04
USPC 705/37

(57) ABSTRACT

According to one embodiment, a market information simulator delivers a simulation time faster than a real time to a market simulator. The market information simulator delivers historical market information including the same time as the simulation time to an algorithm processor. The algorithm processor orders and determines the historical market information, and sends, to the market simulator, order information in which a time in the historical market information is added to order contents. The market simulator creates market board information from the historical market information. The market simulator determines the market board information and the order information by agreement.

### CROSS REFERENCE TO RELATED APPLICATIONS

This application is a Continuation Application of PCT Application No. PCT/JP2011/057393, filed Mar. 25, 2011 and based upon and claiming the benefit of priority from prior Japanese Patent Application No. 2011-013021, filed Jan. 25, 2011, the entire contents of all of which are incorporated herein by reference.

### FIELD

Embodiments described herein relate generally to a securities trading simulation system.

### BACKGROUND

A conventional market simulator is made for an order management system (hereinafter referred to as an OMS) used to manually order securities. In the market simulator of this type, a buy order including a buy amount and a buy quantity and a sell order including a sell amount and a sell quantity are input from an OMS screen, each of the orders is registered in a market board information, and the corresponding amounts of the buy quantity and the sell quantity at the same buy amount and sell amount as those in the market board information are reported to the OMS as a buy agreement and a sell agreement. The agreement means the achievement of the buy and sale of a stock. The market board information is information that lists sell amount and sell quantities/buy amount and buy quantities in descending order of prices. The buy agreement and the sell agreement are not only reached by the above-mentioned corresponding amount but also reached by the corresponding quantities of a sell record low and a buy market order or the corresponding quantities of a buy record high and a sell market order. The market order is a method that does not designate a desired price in selling/buying a stock.

Furthermore, in the market simulator, market information is input tick by tick, market board information is created from the market information, and a buy order or a sell order input from the OMS screen is brought to an agreement in the same manner as described above and reported to the OMS as a buy agreement or a sell agreement.

The market simulator of this type is capable of properly conducting an execution confirmation test of transaction processing in the OMS ranging from order placement with a stock exchange to an agreement.

However, the conventional market simulator is suited to the transaction processing in the OMS, but has the following disadvantages when examined by the present inventor.

For example, in a market simulation, it may be desired to run an algorithm trading simulation to determine an order price and an order quantity by an order determination from a market information tick event in a recent market price, and to run an agreement simulation based on market board information at an event time during the order determination. However, the conventional market simulator is disadvantageously incapable of running the market simulation that uses the market board information regarding past market prices.

Suppose that the market simulator runs the market simulation that uses the market board information regarding past market prices. In this case, in the market simulation, algorithm processing previously created by a user is used, and past market information in the algorithm processing in algorithm trading is read asynchronously with the reading of same-day market information in the market simulator. Thus, order determination by the algorithm processing is asynchronous with the creation of the market board information by the market simulator. This disadvantageously prevents an accurate market simulation. Particularly when the past market information is read at high speed, the creation of the market board information based on the market information moves ahead by a response time difference between the order determination by the algorithm processing and the agreement determination by the market simulator. This leads to a situation where a meaningful market simulation cannot be run.

An object of the present invention is to provide a securities trading simulation system capable of running an accurate market simulation even if historical market information are read at high speed.

### BRIEF DESCRIPTION OF THE DRAWINGS

FIG. 1 is a schematic diagram showing a securities trading simulation system and its peripheral configuration according to an embodiment;

FIG. 2 is a schematic diagram showing a data structure of market board information according to the embodiment;

FIG. 3 is a schematic diagram illustrating agreement determining conditions and a quantity executed according to the embodiment;

FIG. 4 is a schematic diagram illustrating the calculation of profit-and-loss information according to the embodiment;

FIG. 5 is a schematic diagram illustrating the operation according to the embodiment;

FIG. 6 is a schematic diagram showing an example of historical market information according to the embodiment;

FIG. 7 is a schematic diagram showing an example of order information according to the embodiment;

FIG. 8 is a schematic diagram showing an example of order receiving information according to the embodiment;

FIG. 9 is a schematic diagram illustrating the operation according to the embodiment;

FIG. 10 is a schematic diagram showing an example of the historical market information according to the embodiment;

FIG. 11 is a schematic diagram showing an example of agreement information according to the embodiment; and

FIG. 12 is a schematic diagram showing an example of market information according to the embodiment.

### DETAILED DESCRIPTION

In general, according to one embodiment, a securities trading simulation system uses historical market information including the time of securities trading, and comprises a market information simulator, a market simulator, a market information receiving program, and an order execution program.

An algorithm processor performs algorithm processing based on an algorithm processing program previously created by a user. The algorithm processing includes processing to call market information receiving processing when the historical market information is delivered, processing to order and determine the historical market information received by the market information receiving processing, processing to output order contents obtained by the order determination to the market information receiving processing, and processing to call order execution processing after the output of the order contents.

The market information simulator is configured to communicate with the algorithm processor.

The market simulator is configured to communicate with the market information simulator and the algorithm processor.

The market information receiving program causes the algorithm processor to perform market information receiving processing. The market information receiving processing includes processing to receive the historical market information delivered from the market information simulator when called by the algorithm processing, and processing to write, to a first memory, order information in which a time in the historical market information is added to the output order contents.

The order execution program causes the algorithm processor to perform the order execution processing.

The order execution processing is processing to send the order information in the first memory to the market information simulator when called by the algorithm processing.

The market information simulator delivers a simulation time faster than a real time to the market simulator. Historical market information writing device of the market information simulator writes the historical market information including the same time as the simulation time to a second memory. The market information simulator delivers the historical market information to the algorithm processor.

The market simulator creates market board information from the historical market information including the same time as the simulation time, and writes the market board information to a third memory. The market simulator determines the market board information and the order information by agreement, and sends obtained agreement information.

Hereinafter, an embodiment will be described with reference to the drawings. Each device described below can be embodied by a hardware configuration or a combined configuration of hardware resources and software. A program used as the software of the combined configuration is previously installed in a computer of a corresponding device from a network or a storage medium, and enables the function of the corresponding device.

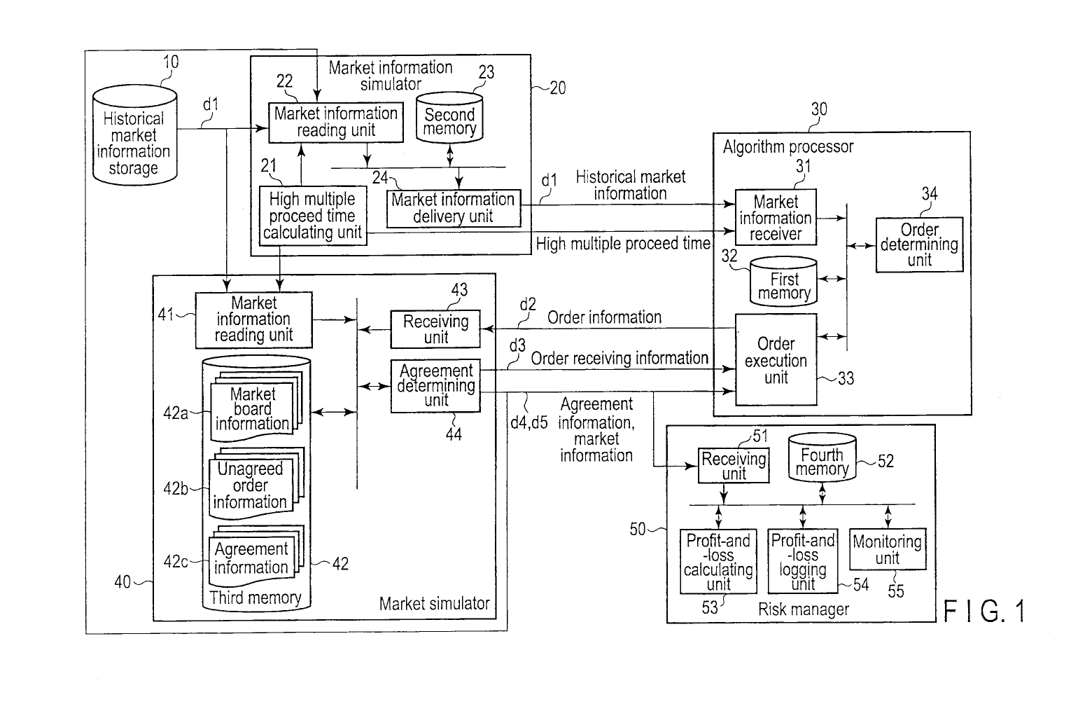

FIG. 1 is a schematic diagram showing a securities trading simulation system and its peripheral configuration according to an embodiment. This securities trading simulation system verifies algorithm processing previously created by a user for an algorithm processor which performs the algorithm processing. Accordingly, the securities trading simulation system comprises a historical market information storage 10, a market information simulator 20, a market information receiving program of a market information receiver 31 and an order execution program of an order execution unit 33 that are called by the algorithm processing, a market simulator 40, and a risk manager 50. The market information receiving program and the order execution program are executed by an algorithm processor 30. The market information simulator 20, the algorithm processor 30, and the market simulator 40 are configured to communicate with one another.

Here, the historical market information storage 10 is a storage in which to previously store historical market information including the time of securities trading and which is readable from the market information simulator 20 and the market simulator 40. Here, the historical market information is also called a tick, and is a receiving unit of market price report information (market information) delivered by, for example, a stock exchange. The historical market information includes, for example, a date indicating the date of the securities trading, a time stamp indicating the time of the securities trading, an issue code for identifying the brand of securities, a last price indicating the current price of the securities, a volume indicating the turnover of the securities, a bid price indicating the estimated buy amount of securities, a bid quantity indicating the estimated buy quantity of the securities, an asked price indicating the estimated sell amount of the securities, an asked quantity indicating the estimated selling quantity of the securities, a market price selling quantity indicating the asked quantity of a market order without price designation, and a market price buy quantity indicating the bid quantity of a market order without price designation. The “time stamp” may be called “time data” or may be abbreviated to “time”. The same also applies to time stamps of other information and an order time stamp.

The market information simulator 20 comprises a high multiple proceed time calculating unit 21, a market information reading unit 22, a second memory 23, and a market information delivery unit 24.

The high multiple proceed time calculating unit 21 has a function to calculate a high multiple proceed time (simulation time) faster than a real time, and a function to deliver the calculated high multiple proceed time to the market simulator 40. However, the high multiple proceed time calculating unit 21 may also deliver the high multiple proceed time to the algorithm processor 30.

Here, the high multiple proceed time is the time used in the securities trading simulation system, and is calculated as shown in the following equation:

Th=9:00+(Tc−Ts)×a

wherein Th is the high multiple proceed time, 9:00 is a market start time, Tc is the current time, Ts is a simulation start time, and a is a high multiple proceed number.

For example, the high multiple proceed time Th is calculated as shown in the following equation:

$$\begin{matrix}Th = 9 : 00 : 00.000 + ( Tc - Ts ) \times a \\ = 9 : 00 : 00.000 + ( 10 : 00 : 50.000 - 10 : 00 : 00.000 ) \times 360 \\ = 9 : 00 : 00.000 + 5 : 00 : 00.000 \\ = 14 : 00 : 00.000\end{matrix}$$

wherein the current time Tc=10:00:50.000, the simulation start time Ts=10:00:00.000, and the high multiple proceed number a=360.

The market information simulator 20, the algorithm processor 30, and the market simulator 40 operate by using the high multiple proceed time Th as a system time. The high multiple proceed time Th may be calculated by, for example, timer processing per about 100 milliseconds.

The high multiple proceed number has only to be set at 360 so that, for example, six hours (360 minutes) from 9 a.m. to 3 p.m. may be one minute. The high multiple proceed number is not limited thereto. Any value within 200 to 900 corresponding to several hundred times the actual market information delivery speed may be properly used as the high multiple proceed number.

The market information reading unit 22 has a historical market information writing function to write, to the second memory 23, historical market information including a time stamp of the same time as the high multiple proceed time calculated by the high multiple proceed time calculating unit 21. The historical market information writing function has a function to read, from the historical market information storage 10, the historical market information including the time stamp of the same time as the high multiple proceed time every high multiple proceed time delivered from the high multiple proceed time calculating unit 21. The historical market information writing function may have a function to add the same time as the high multiple proceed time to the historical market information, a function to update, after the addition, an indicative quantity included in the historical market information to subtract an agreed quantity indicated in the agreement information in response to the agreement information sent from the market simulator 40, and a function to write the historical market information to the second memory 23 after the update.

Alternatively, the historical market information writing function may include a function to add the same time as the high multiple proceed time to the historical market information, a function to determine whether the difference between the currently added time and the previously added time is less than or equal to a constant micro-time (about 10 milliseconds), a function to write historical market information including the currently added time to the second memory 23 when the difference is determined to be less than or equal to the constant micro-time, a function to wait until the receipt of the agreement information when the difference is determined to be beyond the constant micro-time, a function to update an indicative quantity included in the historical market information to subtract an agreed quantity indicated in the agreement information in response to the agreement information during the wait, and a function to write the historical market information to the second memory 23 after the update. Not only, for example, 10 milliseconds but also, for example, a value within 7 to 20 milliseconds can be used as the constant micro-time.

The second memory 23 is a memory that is readable and writable from the market information reading unit 22 and the market information delivery unit 24. The historical market information is temporarily stored in the second memory 23.

The market information delivery unit 24 has a function to deliver the historical market information in the second memory 23 to the algorithm processor 30.

The algorithm processor 30 executes an algorithm processing program previously created by the user to perform algorithm processing, and also executes the market information receiving program and the order execution program previously provided to the user to perform market information receiving processing and the order execution processing. Here, the algorithm processor 30 comprises the market information receiver 31, a first memory 32, the order execution unit 33, and order determining unit 34.

The market information receiver 31 is a functional unit obtained when a CPU (not shown) executes the market information receiving program stored in the first memory 32. The market information receiving program is a program to, when called by the algorithm processing, cause the algorithm processor 30 to perform the market information receiving processing including processing to receive the historical market information delivered from the market information simulator 20, and processing to write, to the first memory 32, order information in which a time in the historical market information is added to the order contents output by the algorithm processing. The market information receiving processing may further include processing to send, to the market simulator 40, an order determination completion report indicating the completion of an order determination when no order contents are obtained by the order determination in the algorithm processing and no order contents are output from the algorithm processing. The programs provided to the user by the securities trading simulation system are the market information receiving program and the order execution program. The programs are provided as an object class library, and are called from the algorithm processing based on the algorithm processing program created by the user.

The first memory 32 is a memory that is readable and writable from the market information receiver 31 and the order execution unit 33. For example, the order information, order receiving information, and the agreement information are stored in the first memory 32.

The order execution unit 33 is a functional unit obtained when the CPU (not shown) executes the order execution program stored in the first memory 32. The order execution program is a program to, when called by the algorithm processing, cause the algorithm processor 30 to perform processing to send the order information in the first memory 32 to the market simulator 40. The order execution program may further cause the algorithm processor 30 to perform processing to write, to the first memory 32, the order receiving information, the agreement information, and the market information independently received from the market simulator 40.

The order determining unit 34 is a functional unit obtained when the CPU (not shown) executes the algorithm processing program stored in the first memory 32. The algorithm processing program is a program which causes the algorithm processor 30 to perform the algorithm processing including processing (receipt callback processing) to call market information receiving processing when the historical market information is delivered from the market information simulator 20, processing to order and determine the historical market information received by the market information receiving processing, processing to output, to the market information receiving processing, order contents obtained by the order determination, processing to call the order execution processing after the output of the order contents. The algorithm processing may further include processing (timer starting processing) to compare the high multiple proceed time delivered from the market information simulator 20 with a preset order time, and write, to the first memory 32, order information in which the high multiple proceed time is added to the preset order time when the high multiple proceed time and the preset order time correspond to each other. The algorithm processing may also include processing to add the high multiple proceed time to the order contents to create order information when order is determined by, for example, the receipt of the agreement information. The order information includes, for example, an order time stamp indicating an order time; an issue code for identifying the brand of securities, sale/buy indicating the sale/buy of the securities, a price condition indicating whether to sell at an asked price, buy at a bid price, or buy at a last price, a quantity indicating the quantity of securities trading, and an execution condition indicating, for example, whether to trade at the closing time.

The market simulator 40 comprises a market information reading unit 41, a third memory 42, a receiving unit 43, and an agreement determining unit 44.

The market information reading unit 41 has a market board information writing function to create market board information from the historical market information including the same time as the high multiple proceed time delivered from the market information simulator 20 and write the market hoard information to the third memory 42. The market board information writing function has a function to read the historical market information including the same time as the high multiple proceed time from the recent market information storage 10 every high multiple proceed time delivered from the market information simulator 20, and a function to create market board information to include a time in the read historical market information every high multiple proceed time delivered from the market information simulator 20. When the historical market information represents an asked price and an asked quantity by a difference, market board information of a day is created by integration per reception in a time-series manner for each brand. In addition, the historical market information is the accumulation of market information actually received from the stock exchange, is snap information only including changed information portions for each information change, and has the same data structure as market board information 42a. In order to create the market board information 42a, it is only necessary to read the historical market information in a time-series manner and overwrite and update changed portions.

The third memory 42 is a memory that is readable and writable from the market information reading unit 41, the receiving unit 43, and the agreement determining unit 44. For example, the market board information 42a, unagreed order information 42b, and agreement information 42c are stored in the third memory 42.

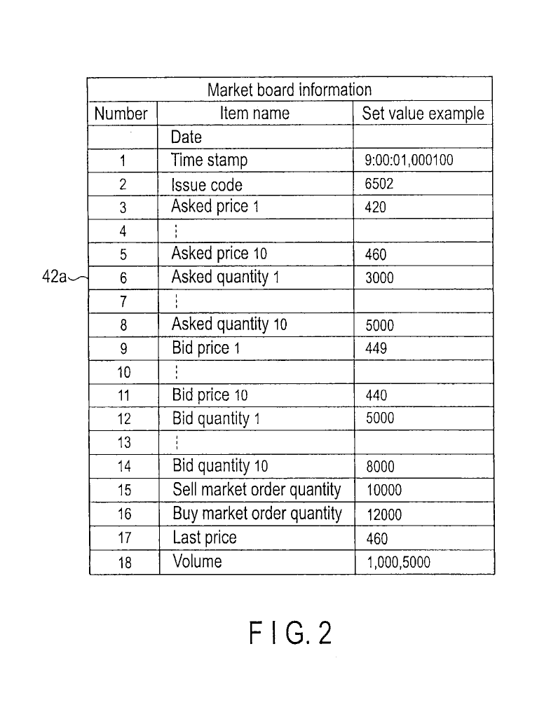

For example, as shown in FIG. 2, the market board information 42a includes a date, a time stamp (time data), an issue code, multiple asked prices, multiple asked quantities, multiple bid prices, multiple bid quantities, a sell market order quantity, a buy market order quantity, and an item name and its set value indicating a last price and a volume.

The receiving unit 43 has a function to receive order information from the algorithm processor 30, and a function to write the received order information to the third memory 42. The receiving unit 43 may output the received order information to the agreement determining unit 44 without writing the information to the third memory 42. The receiving unit 43 may further include a function to send the agreement information 42c in the third memory to the market information simulator 20 in response to the order determination completion report sent from the algorithm processor 30.

The agreement determining unit 44 has a function to determine, by agreement, the market board information 42a written in the third memory 42 and the order information received from the algorithm processor 30, and send obtained agreement information.

Here, the agreement information includes, a time stamp indicating an order time, an issue code, an execution price indicating an execution price, and a buy quantity (or selling quantity).

The agreement determining unit 44 may also have a function to read, in accordance with a time included in the order information received from the algorithm processor, the market board information 42a including a most recent time simultaneous with or later than the above time from the third memory 42, a function to write the order information to the third memory 42 as the unagreed order information 42b when the determination by agreement of the received order information and the read market board information 42a indicates an unreached agreement, and a function to delete the unagreed order information 42b from the third memory 42 and write the agreement information 42c indicating a reached agreement to the third memory 42 when the determination by agreement of the read unagreed order information 42b and the read market board information 42a indicates the reached agreement.

The agreement determining unit 44 may further have a function to send the agreement information 42c in the third memory 42 to the market information simulator 20 in response to the order determination completion report sent from the algorithm processor 30.

In addition, the agreement determining unit 44 has a function to conduct searches (i) and (ii) regarding the order information received by the receiving unit 43.

(i) Reversing Trade Search for Market Board Information

The agreement determining unit 44 searches the third memory 42 for the initial market board information 42a that satisfies the condition: market board information time stamp≦order information time stamp. That is, the agreement determining unit 44 searches the third memory 42 for the most recent market board information 42a after ordering.

(ii) Reversing Trade Search for Order Information

The agreement determining unit 44 searches the third memory 42 for the unagreed order information 42b that satisfies the condition: time stamp of unagreed order information regarding past reversing trades current order time stamp. That is, the agreement determining unit 44 searches the third memory 42 for all the unagreed order information 42b regarding the reversing trades ordered in the past before the current order.

The agreement determining unit 44 determines by agreement after (ii), and therefore registers as the unagreed order information 42b if there is an indicative quantity of the reversing trade at the time of ordering and if there is no instant trade. Agreement information can be then sent at the point where order information regarding the reversing trade is received or the point where an agreement is reached by the creation of market board information including an indicative price of the reversing trade.

The agreement determining unit 44 also has a function to conduct a search (iii) regarding the market board information created by the market information reading unit 41.

(iii) Reversing Trade Search for Order Information

The agreement determining unit 44 searches the third memory 42 for order information that satisfies the condition: time stamp of market board information>time stamp of order information. That is, the agreement determining unit 44 searches the third memory 42 for all the unagreed order information regarding the past orders before the created market board information.

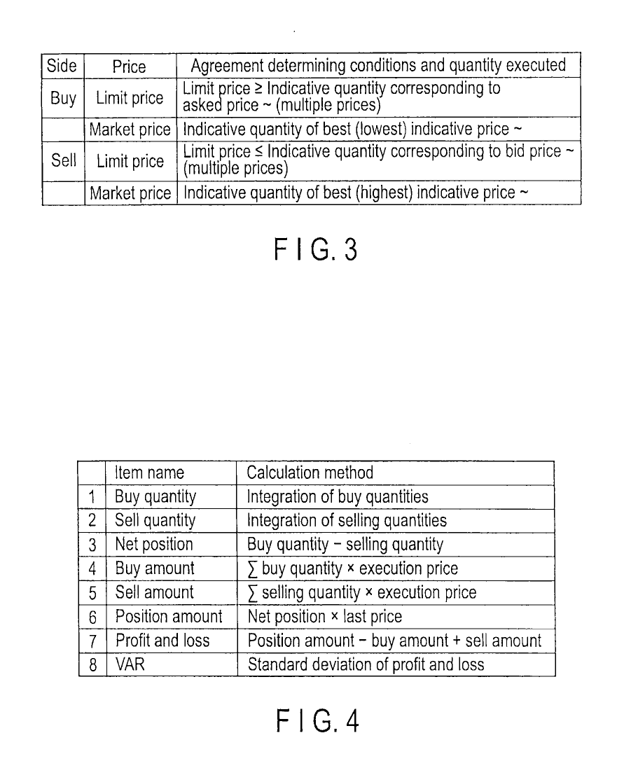

As shown in FIG. 3, the agreement determining unit 44 uses four agreement determining conditions and quantities executed. That is, a buyer agrees to an indicative quantity corresponding to multiple asked prices less than or equal to a limit price in the case of a limit order that designates a desired price. A buyer agrees to the indicative quantity of the best indicative price in the case of a market order that does not designate a desired price. On the other hand, a seller agrees to an indicative quantity corresponding to multiple bid prices less than or equal to a limit price in the case of a limit order that designates a desired price. A seller agrees to the indicative quantity of the best indicative price in the case of a market order that does not designate a desired price.

The risk manager 50 comprises a receiving unit 51, a fourth memory 52, a profit-and-loss calculating unit 53, a profit-and-loss logging unit 54, and a monitoring unit 55.

The receiving unit 51 has a function to receive agreement information and market information from the market simulator 40, and a function to write the received agreement information and market information to the fourth memory 52. The receiving unit 51 may output the received agreement information and market information to the profit-and-loss calculating unit 53 without writing the information to the fourth memory 52.

The fourth memory 52 is a storage unit that is readable and writable from the receiving unit 51, the profit-and-loss calculating unit 53, the profit-and-loss logging unit 54, and the monitoring unit 55. The agreement information, the market information, profit-and-loss information are stored in the fourth memory 52.

The profit-and-loss calculating unit 53 has a function to calculate the profit-and-loss information in accordance with the agreement information sent from the market simulator 40, and a function to write the calculated profit-and-loss information to the fourth memory 52. Here, the profit-and-loss information may be position profit-and-loss information (position amount). As shown in FIG. 4, the profit-and-loss information has items such as a buy quantity, a selling quantity, a net position, a buy amount, a sell amount, a position amount, profit and loss, and VAR. Each item is calculated as below. The profit-and-loss information may be calculated for each issue code.

buy quantity=integration of buy quantities

selling quantity=integration of selling quantities

net position=buy quantity−selling quantity

buy amount=Σbuy quantity×execution price

sell amount=Σselling quantity×execution price

position amount=net position×last price

profit and loss=position amount−buy amount+sell amount

VAR=standard deviation of profit and loss

The profit-and-loss logging unit 54 has a function to create daily profit-and-loss information including final profit-and-loss information for each date and the relevant date out of the profit-and-loss information in the fourth memory 52, and write the daily profit-and-loss information to the fourth memory 52.

The monitoring unit 55 has a function to display the profit-and-loss information and the daily profit-and-loss information in the fourth memory 52.

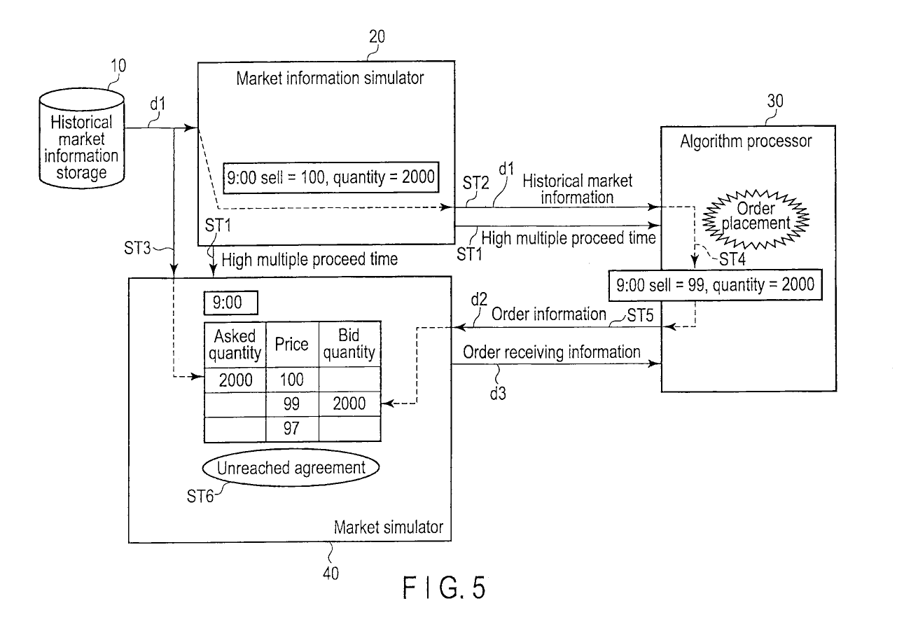

Now, the operation of the securities trading simulation system having the above configuration is described with reference to the schematic diagrams in FIG. 5 to FIG. 12. It should be noted that in the algorithm processor 30, the market information receiving program, an order determining program, and the order execution program are being executed by the unshown CPU so that the functional units 31, 33, and 34 are obtained. Data unrelated to the explanation of the operation are not shown in information d1 to d5.

First, in the market information simulator 20, the high multiple proceed time calculating unit 21 calculates a high multiple proceed time faster than a real time, and delivers the high multiple proceed time to the market simulator 40 and the algorithm processor 30 (ST1).

Suppose that the high multiple proceed time is 9:00:01.234 now.

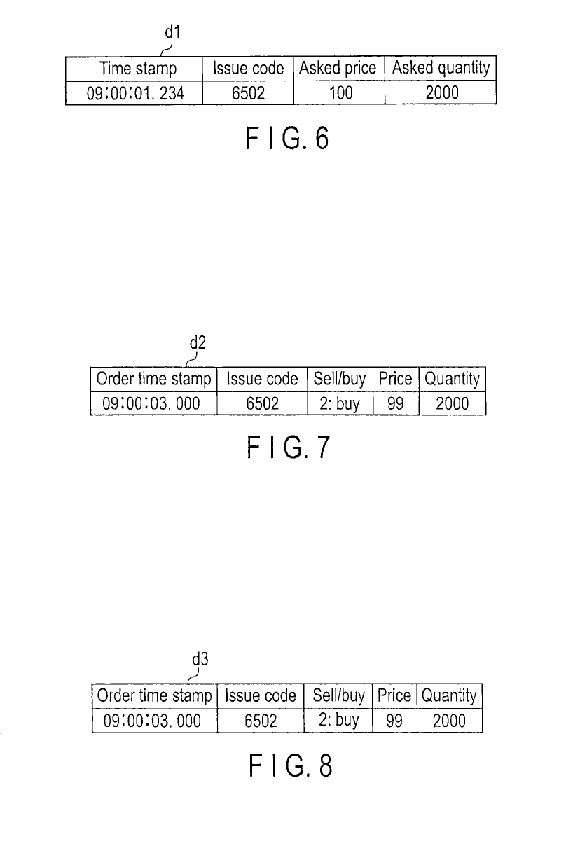

In the market information simulator 20, as shown in FIG. 5 and FIG. 6, the market information reading unit 22 reads, from the recent market information storage 10, historical market information d1 including a time stamp of the same time as the high multiple proceed time, and writes the historical market information d1 to the second memory 23. The market information delivery unit 24 delivers the historical market information d1 in the second memory 23 to the algorithm processor 30 (ST2).

In the market simulator 40, the market information reading unit 41 reads the historical market information d1 including the same time as the high multiple proceed time from the historical market information storage 10 every high multiple proceed time delivered in step ST1 (ST3). The market information reading unit 41 then creates market board information 42a to include a time in the read historical market information every high multiple proceed time.

On the other hand, in the algorithm processor 30, the algorithm processing in the order determining unit 34 calls market information receiving processing in the market information receiver 31 when the historical market information d1 is delivered in ST2. When called by the algorithm processing, the market information receiving processing in the market information receiver 31 receives the historical market information delivered from the market information simulator 20. The algorithm processing in the order determining unit 34 orders and determines the historical market information received by the market information receiving processing, and outputs obtained order contents to the market information receiving processing. The market information receiving processing in the market information receiver 31 writes, to the first memory 32, order information in which a time in the historical market information is added to the order contents output by the algorithm processing (ST4). Here, for example, when market information including an asked price=100 is received, an algorithm intended to create order information including a bid price (=99) derived from asked price−one yen is used as an order determining algorithm. The market information receiving processing in the market information receiver 31 sends, to the market simulator 40, an order determination completion report indicating the completion of an order determination when no order contents are obtained by the order determination in the algorithm processing and no order contents are output from the algorithm processing. However, the case where order information is obtained is mainly described in the present embodiment.

In the algorithm processor 30, the algorithm processing in the order determining unit 34 calls order execution processing after the output of the order contents. When called by the algorithm processing, the order execution processing in the receiving unit 43 sends order information d2 in the first memory 32 to the market simulator 40 as shown in FIG. 7 (ST5).

In the market simulator 40, the receiving unit 43 receives the order information d2 and sends the order information d2 to the agreement determining unit 44. The receiving unit 43 sends agreement information in the third memory to the market information simulator 20 in response to the order determination completion report. However, the case where order information is received is mainly described in the present embodiment.

The agreement determining unit 44 determines, by agreement, the market board information 42a in the third memory 42 and the received order information. At the point of 9:00, as there is no asked price “99” corresponding to a trade “2: buy” and a price “99” in the order information d2, the determination by agreement of the order information d2 and the market board information 42a indicates an unreached agreement (ST6), so that the order information d2 is written to the third memory 42 as unagreed order information. As shown in FIG. 8, the agreement determining unit 44 then sends order receiving information d3 including the contents of the order information d2 to the algorithm processor 30 (ST7).

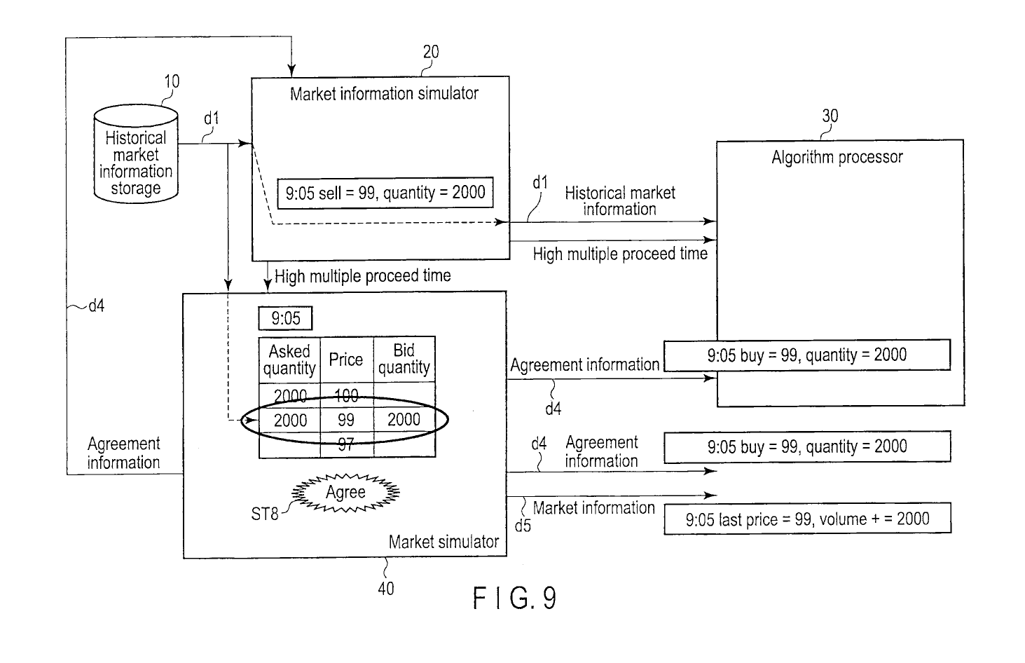

Now, as shown in FIG. 9, suppose that the high multiple proceed time is 9:05:02.001.

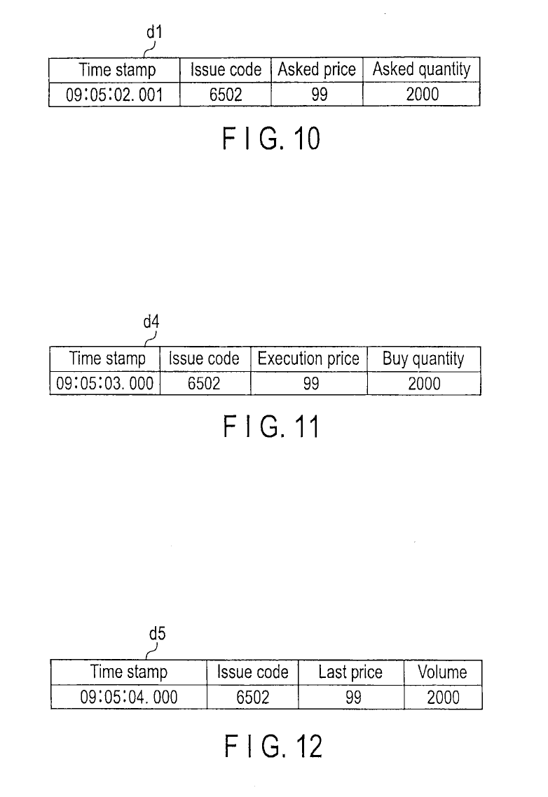

In the market simulator 40, as shown in FIG. 10, the market information reading unit 41 reads, from the historical market information storage 10, the historical market information d1 including the same time as the delivered high multiple proceed time in the same manner as described above. It should be noted that the historical market information d1 also includes the asked price “99”. The market information reading unit 41 creates market board information 42a to include a time in the historical market information.

The agreement determining unit 44 searches the third memory 42 for all the unagreed order information regarding the past orders before the created market board information 42a. The agreement determining unit 44 then determines, by agreement, the created market board information 42a and the retrieved order information, and obtains a result indicating a reached agreement because there is an asked price “99” corresponding to the trade “2: buy” and the price “99” in the unagreed order information d2 (ST8). In this way, the agreement determining unit 44 deletes the unagreed order information from the third memory 42, and writes the agreement information 42c indicating a reached agreement to the third memory 42, and then sends agreement information d4 to the market information simulator 20, the algorithm processor 30, and the risk manager 50, as shown in FIG. 11. The agreement determining unit 44 also sends market information d5 to the risk manager 50 as shown in FIG. 12.

In the risk manager 50, the receiving unit 51 outputs the received agreement information and market information to the profit-and-loss calculating unit 53. In accordance with agreement information, the profit-and-loss calculating unit 53 adds up the quantities and prices for each issue code and performs a real-time calculation of profit-and-loss information. The profit-and-loss calculating unit 53 then writes the calculated profit-and-loss information to the fourth memory 52. The profit-and-loss logging unit 54 creates daily profit-and-loss information including final profit-and-loss information for each date and the relevant date out of the profit-and-loss information in the fourth memory 52, and writes the daily profit-and-loss information to the fourth memory 52.

The monitoring unit 55 displays the profit-and-loss information and the daily profit-and-loss information in the fourth memory 52.

Furthermore, in the market information simulator 20, the market information reading unit 22 adds the same time as the high multiple proceed time to the historical market information. The market information reading unit 22 updates an indicative quantity included in the historical market information to subtract an agreed quantity indicated in the agreement information d4 in response to the agreement information d4 sent from the market simulator 40. The market information reading unit 22 then writes the historical market information to the second memory 23 after the update.

Processing is then performed in the same manner as described above.

The market information reading unit 22 may also operate as below. That is, the market information reading unit 22 adds the same time as the high multiple proceed time to the historical market information, and then determines whether the difference between the currently added time and the previously added time is less than or equal to a constant micro-time (about 10 milliseconds). The market information reading unit 22 writes historical market information including the currently added time to the second memory 23 when the difference is determined to be less than or equal to the constant micro-time. On the other hand, when the difference is determined to be beyond the constant micro-time, the market information reading unit 22 waits until the receipt of the agreement information. The market information reading unit 22 updates an indicative quantity included in the historical market information to subtract an agreed quantity indicated in the agreement information in response to the agreement information during the wait. The market information reading unit 22 then writes the historical market information to the second memory 23 after the update.

In any case, processing is performed in the same manner as described above after the writing of the historical market information.

As described above, according to the present embodiment, the reading of the historical market information, the creation of the order information, the creation of the market board information, and the agreement determination are conducted on the basis of the high multiple proceed time calculated by the market information simulator 20. This configuration permits the synchronization of the time stamp in the historical market information, the order time stamp in the order information, and the time stamp in the market board information. Therefore, even if the historical market information is read at high speed, an accurate market simulation can be run.

The configuration that synchronizes the order time stamp in the order information with the time stamp in the market board information permits an accurate simulation of an execution price and a quantity executed included in the agreement information. Moreover, as profit and loss can also be simulated as profit and loss resulting from execution at the recent market price, an accurate profit-and-loss simulation can be run in the algorithm processor 30. The user can tune the algorithm processor 30 by the improvement of the algorithm processing program of the order determining unit 34 based on the result of the accurate profit-and-loss simulation.

Furthermore, in the market information simulator 20, an indicative quantity included in the historical market information is updated to subtract an agreed quantity indicated in the agreement information d4 sent from the market simulator 40. Therefore, the agreement information can be reflected in the historical market information, so that a more accurate profit-and-loss simulation can be run.

The method described in the embodiment can also be stored in a storage medium such as a magnetic disk (Floppy™ disk, hard disk, or the like), an optical disk (CD-ROM, DVD, or the like), a magneto-optical disk (MO), or a semiconductor memory as a program which can be executed by a computer and distributed.

As the storage medium, any configuration which is a computer-readable storage medium in which a program can be stored may be used regardless of a storage format.

An OS (operating system) which operates on a computer on the basis of an instruction of a program installed from the storage medium in the computer, database management software, and MW (middleware) such as network software may execute a part of the processes to realize the embodiment.

Furthermore, the storage medium according to the present invention includes not only a medium independent of a computer but also a storage medium in which a program transmitted through a LAN, the Internet, or the like is downloaded and stored or temporarily stored.

The number of storage media is not limited to one. A case in which the process in the embodiment is executed from a plurality of media is included in the storage medium according to the present invention. Any medium configuration may be used.

A computer according to the present invention is to execute the processes in the embodiments on the basis of the program stored in a storage medium. The computer may have any configuration such as one apparatus constituted by a personal computer or a system in which a plurality of apparatuses are connected by a network.

A computer in each embodiment includes not only a personal computer but also an arithmetic processing apparatus, a microcomputer, or the like included in an information processing apparatus. The computer is a generic name of an apparatus and a device which can realize the functions of the present invention by a program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A securities trading simulation system which uses historical market information including the time of a securities trade, the securities trading simulation system comprising:
a market information simulator configured to communicate with an algorithm processor which performs algorithm processing based on an algorithm processing program previously created by a user, the algorithm processing including processing to call market information receiving processing when the historical market information is delivered, processing to order and determine the historical market information received by the market information receiving processing, processing to output order contents obtained by the order determination to the market information receiving processing, and processing to call order execution processing after the output of the order contents;
a market simulator configured to communicate with the market information simulator and the algorithm processor;
a market information receiving program which causes the algorithm processor to perform market information receiving processing, the market information receiving processing including processing to receive the historical market information delivered from the market information simulator when called by the algorithm processing, and processing to write, to a first memory, order information in which a time in the historical market information is added to the output order contents; and
an order execution program which causes the algorithm processor to perform the order execution processing to send the order information in the first memory to the market information simulator when called by the algorithm processing,
the market simulator comprising
a device which delivers a simulation time faster than a real time to the market simulator,
a historical market information writing device which writes the historical market information including the same time as the simulation time to a second memory, and
a device which delivers the historical market information to the algorithm processor,
the market simulator comprising
a market board information writing device which creates market board information from the historical market information including the same time as the simulation time, and writes the market board information to a third memory, and
a device which determines, by agreement, the market board information and the order information, and sends obtained agreement information.

2. The securities trading simulation system according to claim 1, further comprising
a risk manager configured to communicate with the market simulator,
the risk manager comprising
a device which calculates the profit-and-loss information in accordance with the sent agreement information, and
a device which displays the profit-and-loss information.

3. The securities trading simulation system according to claim 2, wherein
the profit-and-loss information is position profit-and-loss information.

4. The securities trading simulation system according to claim 1, further comprising
a storage device which previously stores the historical market information, the storage device being readable from the market information simulator and the market simulator,
wherein the historical market information writing device comprises
a module which reads the historical market information including the same time as the simulation time from the storage device every simulation time to be delivered,
the market board information writing device comprising
a module which reads the historical market information including the same time as the simulation time from the storage device every simulation time which has been delivered, and
a module which creates the market board information to include a time in the read historical market information every simulation time which has been delivered.

5. The securities trading simulation system according to claim 4, wherein
the market simulator comprises
a device which receives the order information from the algorithm processor,
a device which reads, in accordance with a time included in the received order information, the market board information including a most recent time simultaneous with or later than the above time from the third memory,
a device which writes the order information to the third memory as unagreed order information when the determination by agreement of the received order information and the read market board information indicates an unreached agreement,
a device which reads, in accordance with the time included in the received order information, unagreed order information including a time earlier than the above time from the third memory, and
a device which deletes the unagreed order information from the third memory and writes agreement information indicating a reached agreement to the third memory when the determination by agreement of the read unagreed order information and the read market board information indicates the reached agreement.

6. The securities trading simulation system according to claim 1, wherein
the market simulator further comprises
a device which receives the order information from the algorithm processor, and
a device which writes the received order information to the third memory.

7. The securities trading simulation system according to claim 1, wherein
the market information simulator further comprises
a device which delivers the simulation time to the algorithm processor, and
the algorithm processing further comprises processing to compare the delivered simulation time with a preset order time, and output preset order contents to the market information receiving processing when the delivered simulation time and the preset order time correspond to each other.

8. The securities trading simulation system according to claim 1, wherein
the market simulator further comprises
a device which receives the order information from the algorithm processor,
a device which reads, in accordance with a time included in the received order information, the market board information including a most recent time simultaneous with or later than the above time from the third memory,
a device which writes the order information to the third memory as unagreed order information when the determination by agreement of the received order information and the read market board information indicates an unreached agreement,
a device which reads, in accordance with the time included in the received order information, unagreed order information including a time earlier than the above time from the third memory, and
a device which deletes the unagreed order information from the third memory when the determination by agreement of the read unagreed order information and the read market board information indicates the reached agreement.

9. The securities trading simulation system according to claim 1, wherein
the historical market information writing device comprises
a module which adds the same time as the simulation time to the historical market information,
a module which updates, after the addition, an indicative quantity included in the historical market information to subtract an agreed quantity indicated in the agreement information in response to the sent agreement information, and
a module which writes the historical market information to the second memory after the update.

10. The securities trading simulation system according to claim 1, wherein
the market information receiving processing further comprises processing to send, to the market simulator, an order determination completion report indicating the completion of an order determination when no order contents are obtained by the order determination and no order contents are output from the algorithm processing,
the market simulator further comprises
a device which writes agreement information indicating a reached agreement to the third memory when the agreement determination indicates the reached agreement,
a device which sends agreement information in the third memory to the market information simulator in response to the sent order determination completion report, and
the historical market information writing device comprises
a module which adds the same time as the simulation time to the historical market information,
a module which determines whether the difference between the currently added time and the previously added time is less than or equal to a constant micro-time,
a module which writes historical market information including the currently added time to the second memory when the difference is determined to be less than or equal to the constant micro-time,
a module which waits until the receipt of the agreement information when the difference is determined to be beyond the constant micro-time,
a module which updates an indicative quantity included in the historical market information to subtract an agreed quantity indicated in the agreement information in response to the agreement information during the wait, and
a module which writes the historical market information to the second memory after the update.
